(19) United States
(12) Patent Application Publication
(10) Pub. No.: US 2025/0126497 A1
(43) Pub. Date: Apr. 17, 2025

(54) SYNTHETIC DATA GENERATION USING GAN BASED ON ANALYTICS IN 5G NETWORKS

(71) Applicant: Telefonaktiebolaget LM Ericsson (publ), Stockholm (SE)

(72) Inventors: Carlota VILLASANTE MARCOS, Madrid (ES); Victor GOMEZ-HIDALGO PEREZ, Torrijos Toledo (ES); Gonzalo HERNANDEZ HARO, Madrid (ES); Miguel Angel JULIAN AGUILAR, Madrid (ES); Miguel Angel MUÑOZ DE LA TORRE ALONSO, Madrid (ES); Carlos ÁLAMO GONZÁLEZ, Madrid (ES)

(21) Appl. No.: 18/727,563

(22) PCT Filed: Mar. 16, 2022
(86) PCT No.: PCT/IB2022/052400

§ 371 Date: Jul. 9, 2024

(30) Foreign Application Priority Data
Jan. 17, 2022 (EP) 22382022.6

(51) Int. Cl. H04W 24/06; H04L 41/142; H04L 41/16; H04W 24/08

(52) U.S. Cl. CPC H04W 24/06; H04L 41/142; H04L 41/16; H04W 24/08

(57) ABSTRACT

A Generative Adversarial Network (GAN) is used to generate synthetic network traffic data, such as for use in training Machine Learning (ML) models. In one embodiment, a new NWDAF analytic “SyntheticData” is defined. The analytic receives as input from a requesting network function (NF) at least an amount of network traffic data requested and the type of network traffic data requested. The SyntheticData analytic uses a GAN model to generate realistic synthetic network traffic data based on actual network traffic collected in the wireless communication network. The analytic sends to the requesting NF the specified amount of synthetic network traffic data of the specified type. In one embodiment, the synthetic network traffic data generation is implemented as a new logical function of an NWDAF: the Data Generator Logical Function (DGLF).

### TECHNICAL FIELD

The present invention relates generally to wireless communication networks, and in particular to the generation of high-quality synthetic network traffic using a Generative Adversarial Network (GAN).

### BACKGROUND

Wireless communication networks, enabling voice and data communications to mobile devices, are ubiquitous in many parts of the world, and continue to advance in technological sophistication, system capacity, data rates, bandwidth, supported services, and the like. A basic model of one type of wireless networks, generally known as “cellular,” features a plurality of fixed network nodes (known variously as base station, radio base station, base transceiver station, serving node, NodeB, eNobeB, eNB, gNB, and the like), each providing wireless communication service to a large plurality of mobile devices (known variously as mobile terminals, User Equipment or UE, and the like) within a generally fixed geographical area, known as a cell or sector. The wireless network nodes and UEs are together known as a Radio Access Network (RAN). The protocol and operation of the RAN defines a Radio Access Technology (RAT). The RAN communicates via wired or wireless connections to a core network (CN) comprising numerous nodes implementing network functions, such as mobility management, access control, network policy formulation and enforcement, subscriber identity maintenance, metering and billing, and the like. The CN also includes gateways to other networks, such as landline telephony networks, private digital networks, the Internet, and the like.

Wireless communication networks continue to grow in capacity and sophistication. To accommodate both more users and a wider range of types of devices that may benefit from wireless communications, the technical standards governing the operation of wireless communication networks continue to evolve. The fourth generation (4G, also known as Long Term Evolution, or LTE) of network standards has been deployed, and the fifth generation (5G, also known as New Radio, or NR) is in development. 5G is in an advanced draft stage within the Third Generation Partnership Project (3GPP). 5G wireless access will be realized by the evolution of LTE for existing spectrum, in combination with new radio access technologies that primarily target new spectrum. Thus, it includes work on a 5G New Radio (NR) Access Technology, also known as next generation (NX). The NR air interface targets spectrum in the range from below 1 GHz up to 100 GHZ, with initial deployments expected in frequency bands not utilized by LTE. 5G supports numerous advanced networking concepts, such as network slicing, ultra-reliable low-latency communication (URLLC), multiple-input multiple-output technology (MIMO), beam-steering, and support for massive numbers of Machine Type Communications (MTC) devices.

### Network Architecture and Functionality

FIG. 1 depicts some network functions (NF) of the reference 5G CN architecture. Although conventionally referred to as “nodes,” the NFs depicted in FIG. 1 are more accurately viewed as logical functions. In modern implementations, these functions may be implemented separately or together in physical nodes, and/or may be distributed, such as in cloud computing environments. The network functions depicted in FIG. 1 include Unified Data Repository (UDR), Network Exposure Function (NEF), NetWork Data Analytics Function (NWDAF), Access and Mobility Management Function (AMF), Application Function (AF), Session Management Function (SMF), User Plane Function (UPF), Policy Control Function (PCF), and Charging Function (CHF).

The Unified Data Repository (UDR) stores data grouped into distinct collections of subscription-related information, including Subscription Data, Policy Data, Structured Data for Exposure, and Application Data. The Subscription Data are made available, via the Unified Data Management (UDM) front-end, to a number of NFs that control the UE's activities within the network. The Policy Data are made available to the PCF. Application Data are placed into the UDR by the external Application Functions (AFs), via the Network Exposure Function (NEF), in order to be made available to whichever 5G NF need—and are authorized to request—subscriber-related information.

The Network Exposure Function (NEF) supports different functionality and specifically in the context of this disclosure, NEF supports different Exposure Application Programming Interfaces (APIs). In particular, the NEF securely exposes network capabilities and events provided by 3GPP NFs to AF, and provides a means for the AF to securely provide information to 3GPP NFs. The NEF may translate information between 3GPP NFs and Afs.

The NetWork Data Analytics Function (NWDAF) is a network operator-managed network analytics logical function. The NWDAF is part of the 5G Core Network (5GC) architecture and uses the mechanisms and interfaces specified for 5GC and Operations, Administration and Maintenance (OAM). The NWDAF interacts with different entities for different purposes. For example, it may perform data collection based on event subscription, with data provided by AMF, SMF, PCF, Unified Data Management (UDM), AF (directly or via NEF), and OAM. The NWDAF may retrieve information from data repositories (e.g., Unified Data Repository (UDR) via Unified Data Management (UDM) for subscriber-related information), and may also retrieve information about NFs (e.g., Network Repository Function (NRF) for NF-related information, and Network Slicing Selection Function (NSSF) for slice-related information). The NWDAF may also perform on-demand provision of Data Analytics Functions (DAF), also referred to herein as simply “analytics,” to consumers, such as other NFs, OAM, and the like.

The Access and Mobility Management Function (AMF) receives all connection and session related information from the User Equipment (UE) but is responsible only for handling connection and mobility management tasks. All messages related to session management are forwarded over to the Session Management Function (SMF). The AMF performs the role of access point to the 5G core, thereby terminating RAN control plane and UE traffic.

The Session Management Function (SMF) includes various functionality relating to subscriber sessions, e.g., session establishment, modification, and release. For example, the SMF receives policy and charging control (PCC) rules from the Policy Control Function (PCF) and configures the User Plane Function (UPF) accordingly.

The User Plane Function (UPF) supports handling of user plane traffic based on the rules received from the Session Management Function (SMF), e.g., packet inspection, routing, and forwarding, as well as different enforcement actions such as Quality of Service (QoS) handling. The UPF acts as the external Protocol Data Unit (PDU) session point of interconnect to Data Networks (DN), and is an anchor point for intra-& inter-RAT mobility.

The Application Function (AF) supports Application Servers (AS) providing specific content or services, such as, e.g., streaming music or video. The AF interacts with the 3GPP Core Network, and specifically in the context of this disclosure, allows external parties to use the Exposure APIs offered by the network operator.

The Policy Control Function (PCF) supports a unified policy framework to govern the network behavior. Specifically, the PCF provides Policy and Charging Control (PCC) rules to the Policy and Charging Enforcement Function (PCEF), i.e., the SMF/UPF that enforces policy and charging decisions according to provisioned PCC rules.

The Charging Function (CHF) allows charging services to be offered to authorized network functions.

Each UE in a wireless communication network has (or is assigned) a unique UE-ID which identifies it. Many network operations manage multiple similar UEs as a group, and consequently will assign the same unique UE-Group-ID to the UEs in each group. As used herein, AnyUE is a parameter label which means a function or analytic applies to any UE-ID.

An Access Point Name (APN) is used in LTE in the Domain Name System (DNS), as defined in 3GPP Technical Standard (TS) 29.303, § 19.4.2.2. The Domain Network Name (DNN) is the equivalent identifier in 5G. An APN/DNN comprises two parts: a mandatory Network Identifier, which defines an external network; and an optional Operator Identifier, which defines a connected Public Land Mobile Network (PLMN).

A feature of the 5G network architecture is network slicing. A network slice is defined as a logical (virtual) network customized to serve a defined business purpose or customer, consisting of an end-to-end composition of all the varied network resources required to satisfy the specific performance and economic needs of that particular service class or customer application. A network slice is identified by the Single Network Slice Selection Assistance Information (S-NSSAI). NSSAI is a collection of S-NSSAIs.

A series of packets transferred through a wireless communication system is referred to as a traffic flow. A flow can be defined as an artificial logical equivalent to a call or connection; or more accurately as a sequence of packets sent from a particular source to a particular unicast, anycast, or multicast destination. A traffic flow is defined by a 5-tuple, which refers to a set of five different values that comprise a Transmission Control Protocol/Internet Protocol (TCP/IP) connection. It includes a source IP address/port number, destination IP address/port number and the protocol in use.

Most wireless communication networks provide for connection to the Internet and the World Wide Web (WWW). A Uniform Resource Locator (URL) is a reference to a WWW resource, which specifies the location and retrieval mechanism for the resource. URLs most commonly identify web pages, but are also used for file transfer, email, database access, and the like.

### Machine Learning

Machine Learning (ML) refers to the study of computer algorithms that improve automatically through experience. ML is an outgrowth of the field of artificial intelligence. ML algorithms build a model based on sample data, known as “training data,” in order to make predictions or decisions without being explicitly programmed to do so. Machine learning algorithms are used in a wide variety of applications, such as email filtering and computer vision, where it is difficult or unfeasible to develop conventional algorithms to perform the needed tasks,

There are three basic types of ML techniques: Supervised Learning, Unsupervised Learning, and Reinforcement Learning.

Supervised Learning algorithms consists of a target or outcome variable (dependent variable) which is to be predicted from a given set of predictors (independent variables). Using these sets of variables, a function is generated that maps inputs to desired outputs. The training process continues until the model achieves a desired level of accuracy on the training data. Examples of Supervised Learning include Regression, Decision Tree, Random Forest, k-Nearest Neighbor (KNN), Logistic Regression, etc.

In Unsupervised Learning, there are no target or outcome variables to predict or estimate. Unsupervised Learning is used for clustering populations into different groups, which is widely used for segmenting customers for specific intervention. Examples of Unsupervised Learning include K-means, mean-shift clustering, Density-Based Spatial Clustering of Applications with Noise (DBSCAN), Expectation-Maximization (EM) Clustering using Gaussian Mixture Models (GMM), and Agglomerative Hierarchical Clustering.

Cluster analysis, or clustering, is a ML technique which consists of grouping a set of objects in such a way that objects in the same group (called a cluster) are more similar, in some sense, to each other than to objects grouped into other clusters. Clustering is a main task of exploratory data mining, and a common technique for statistical data analysis, which used in many fields, including pattern recognition, image analysis, information retrieval, bioinformatics, data compression, computer graphics, and other machine learning algorithms.

In Reinforcement Learning, a machine is trained to make specific decisions. The machine is exposed to an environment where it trains itself continually, using trial and error. The machine learns from past experience, and tries to capture the best possible knowledge to make accurate business decisions. One example of Reinforcement Learning is the Markov Decision Process.

Deep Learning is a specialized subset of ML techniques. In Artificial Neural Networks (ANN), logical elements are organized in a structure, and operate according to an algorithm, that mimics the observed operation of neurons in a brain. This leads to a process of learning that is more complex, and also more capable, than standard ML models. ANNs that consists of more than three layers can be considered deep learning algorithms. In contrast to standard ML models, deep learning has huge data needs, and requires little human intervention to function properly. Deep learning is used in a wide range of fields, such as autonomous driving, object identification and classification, generating new data, etc.

Deep learning architectures can be classified into two main groups—Supervised Learning and Unsupervised Learning—each of which includes several popular architectures.

In Supervised Learning, models are used to predict a class label, given an example of input variables.

A Convolutional Neural Network (CNN) is a multilayer neural network particularly useful in image-processing, video recognition, and natural language processing applications. Early layers recognize features, and later layers recombine these features into higher-level attributes of the input.

Recurrent Neural Network (RNN) maintain memory of past inputs, and model problems in time by having connections that feed back into prior layers or into the same layer. This method helps the network to predict an output. Long Short-Term Memory (LSTM) and Gated Recurrent Unit (GRU) are two types of RNNs.

Long Short-Term Memory (LSTM) introduces the concept of a memory cell, which can retain values and information for a short or long time, as a function of the inputs.

Gated Recurrent Unit (GRU) is a simplification of the LSTM-indicating only how much content of the previous cell to maintain, and how to incorporate new data. GRUs be trained more quickly and can be more efficient.

In Unsupervised Learning, models summarize the distribution of input variables, and may be able to be used to create or generate new examples in the input distribution. Self-Organizing Map (SOM) and Autoencoders (AE) are examples of Unsupervised Deep Learning.

A Self-Organizing Map (SOM) creates clusters of the input dataset by reducing the dimensionality of the input. These differ from the traditional ANN, as the weights serve as a characteristic of the node, which represent new input nodes.

An Autoencoders (AE) is a variant of ANN composed of three layers (input, hidden, and output layers). The input layer is first encoded into the hidden layer, which contains a compressed representation of the original input in a fewer number of nodes than the input. Using a decoder function, the output layer aims to reconstruct the input layer. AEs are commonly used for dimensionality reduction, data interpolation, and data compression or decompression.

Generative modeling is a specific ML unsupervised learning task that attempts to automatically discover and learn similarities or patterns in input data, such that the model can be used to generate new data mimicking the original dataset. For example, generative modeling has been used to create photographs of faces that do not exist in the real world, but are highly realistic to human viewers. The approach has also been applied to create artificial yet highly realistic media data such as text, audio, and videos.

A Generative Adversarial Network (GAN) is an approach to generative modeling that frames the problem as a supervised learning problem with two sub-models: a generator model that is trained to generate new data, and a discriminator model that attempts to classify data as either real (from a training set) or fake (generated by the generator model). The two models are trained together in an adversarial, zero-sum game (where one agent's gain is the other's loss), until the discriminator model is fooled about half the time, meaning the generator model is generating plausible datasets. Although originally proposed as a form of generative model for unsupervised learning, GANs have also proven useful for generating realistic data sets for semi-supervised learning, fully supervised learning, and reinforcement learning.

FIG. 2 depicts a general model of a GAN 10, with the two sub-models: a generator 11 and a discriminator 12. Training data 13, which may for example comprise actual images, music, network traffic, or the like, provides real data. The images or the like are sampled 14, if necessary, and input to the discriminator 12. Random input 15, such as pseudo-random noise or the like, are input to the generator 11, which attempts to generate output matching the properties of the training data 13. The generator 11 output are sampled 16, if necessary, and also input to the discriminator 12. For each “round” (e.g., image or the like), the discriminator 12 makes a binary decision-are its input data real (training data 13) or fake (created by the generator 11)? The veracity of the discriminator 12 decision-that is, whether the discriminator 12 or the generator 11 “won” that round, is fed back to both sub-models. Hence, the generator 11 is not trained to minimize the distance to the training data 13 (e.g., a specific image), but rather to fool the discriminator 12. This enables the GAN model 10 to learn in an unsupervised manner.

When the generator 11 wins roughly 50% of the time, it is generating data that mimics the essential properties of the real training data 13. GANs 10 have proven extremely successful in creating artificial yet highly realistic media data such as images, text, audio, and videos.

### The Need for Network Data

Modern wireless communication networks have millions of subscribers, and transfer terabytes of data daily. Various Machine Learning (ML) techniques have been applied to numerous network functions, to optimize their performance. ML is also applied in network operations and maintenance, to automate many tasks, such as the generation of network policies, load balancing, admission control, and the like. Many Application Servers utilize ML techniques to optimize their services. For example, streaming media services utilize ML techniques to customize media suggestions to subscribers, as well as for technical aspects, such as learning peak viewing times and optimizing equipment operation. A common need of all of these ML applications is a large supply of realistic network traffic for training data.

Modern wireless communication networks suffer from high dynamicity; consequently, it is necessary to retrain ML models often, to adapt to new network situations. This implies that the collection of training data from network nodes should optimally be ongoing and permanent. Furthermore, ML models applied to user plane traffic in mobile networks (e.g., for application awareness, intrusion detection, or the like) require training on huge amounts of traffic data (e.g., IP packets or flow-based data sets). The effectiveness of the resulting ML model (e.g., minimizing the false positives) depends directly on the quality (i.e., realism and recency) and volume of traffic data used for training.

It is difficult to obtain real traffic data (e.g., traffic traces consisting of IP packets) from Mobile Network Operators (MNOs), particularly labeled data sets. Few labeled data sets are publicly available which contain realistic user behavior (e.g., up-to-date attack scenarios). Available data sets are often outdated. Even if it were available, the use of real network traffic is problematic. The collection, transport, and saving of network traffic may overload network nodes, without some means of scaling the data. Also, since flow-based data sets contain millions or even billions of flows, manual labeling of real network traffic is difficult and extremely time-consuming. Furthermore, privacy concerns prevent the sharing of real network data.

The Background section of this document is provided to place embodiments of the present invention in technological and operational context, to assist those of skill in the art in understanding their scope and utility. Approaches described in the Background section could be pursued, but are not necessarily approaches that have been previously conceived or pursued. Unless explicitly identified as such, no statement herein is admitted to be prior art merely by its inclusion in the Background section.

### SUMMARY

The following presents a simplified summary of the disclosure in order to provide a basic understanding to those of skill in the art. This summary is not an extensive overview of the disclosure and is not intended to identify key/critical elements of embodiments of the invention or to delineate the scope of the invention. The sole purpose of this summary is to present some concepts disclosed herein in a simplified form as a prelude to the more detailed description that is presented later.

According to embodiments of the present invention disclosed and claimed herein, a Generative Adversarial Network (GAN) is used to generate synthetic network traffic data, such as for use in training Machine Learning (ML) models. In one embodiment, a new NWDAF analytic “SyntheticData” is defined. The analytic receives as input, from a requesting network function (NF) at least an amount of network traffic data requested and the type of network traffic data requested. The SyntheticData analytic uses a GAN model to generate realistic synthetic network traffic data, based on actual network traffic collected in the wireless communication network. The analytic sends to the requesting NF the specified amount of synthetic network traffic data of the specified type. In one embodiment, the synthetic network traffic data generation is implemented as a new logical function of an NWDAF: the Data Generator Logical Function (DGLF).

One embodiment relates to a method, performed by a data analytics function of a wireless communication network, of generating realistic synthetic network traffic data. A request for a SyntheticData analytic is received from a network function. The request specifies at least an amount of network traffic data requested and the type of network traffic data requested. A Generative Adversarial Network, GAN, model is used to generate realistic synthetic network traffic data based on actual network traffic collected in the wireless communication network. The specified amount of synthetic network traffic data, of the specified type, is sent to the requesting network function.

Another embodiment relates to a network node operative in a wireless communication network and implementing a network data analytics function. The network node includes communication circuitry configured to communicate with other nodes of the wireless communication network and processing circuitry. The processing circuitry is operatively connected to the communication circuitry, and is configured to: receive, from a network function, a request for a SyntheticData analytic, the request specifying at least an amount of network traffic data requested and the type of network traffic data requested; use a Generative Adversarial Network, GAN, model to generate realistic synthetic network traffic data based on actual network traffic collected in the wireless communication network; and send, to the requesting network function, the specified amount of synthetic network traffic data of the specified type.

Yet another embodiment relates to a computer-readable medium containing instructions which, when executed by processing circuitry of a network node, are configured to cause the processing circuitry to perform the steps of: receiving, from a network function, a request for a SyntheticData analytic, the request specifying at least an amount of network traffic data requested and the type of network traffic data requested; using a Generative Adversarial Network, GAN, model to generate realistic synthetic network traffic data based on actual network traffic collected in the wireless communication network; and sending, to the requesting network function, the specified amount of synthetic network traffic data of the specified type.

### BRIEF DESCRIPTION OF THE DRAWINGS

The present invention will now be described more fully hereinafter with reference to the accompanying drawings, in which embodiments of the invention are shown. However, this invention should not be construed as limited to the embodiments set forth herein. Rather, these embodiments are provided so that this disclosure will be thorough and complete, and will fully convey the scope of the invention to those skilled in the art. Like numbers refer to like elements throughout.

FIG. 1 is a block diagram of a 5G network architecture.

FIG. 2 is a block diagram of a Generative Adversarial Network.

FIG. 3 is a network signaling diagram of generating synthetic network traffic data, assuming a NWDAF has a trained GAN model.

FIG. 4 is a network signaling diagram showing the steps of FIG. 3 required if the NWDAF does not have a trained GAN model.

FIG. 5 is a network signaling diagram showing the interaction of NWDAF logical functions MTLF and DGLF.

FIG. 6 is a flow diagram depicting steps in a method of generating realistic synthetic network traffic data.

FIG. 7 is a hardware block diagram of a network node implementing a NWDAF having a DGLF.

FIG. 8 is a functional block diagram of a network node implementing a NWDAF having a DGLF.

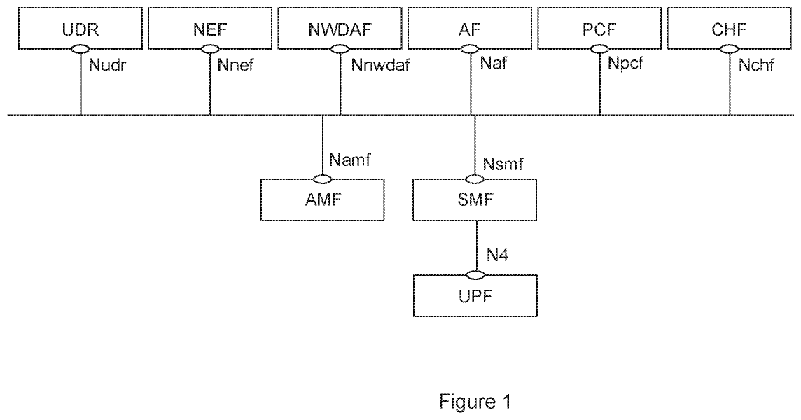

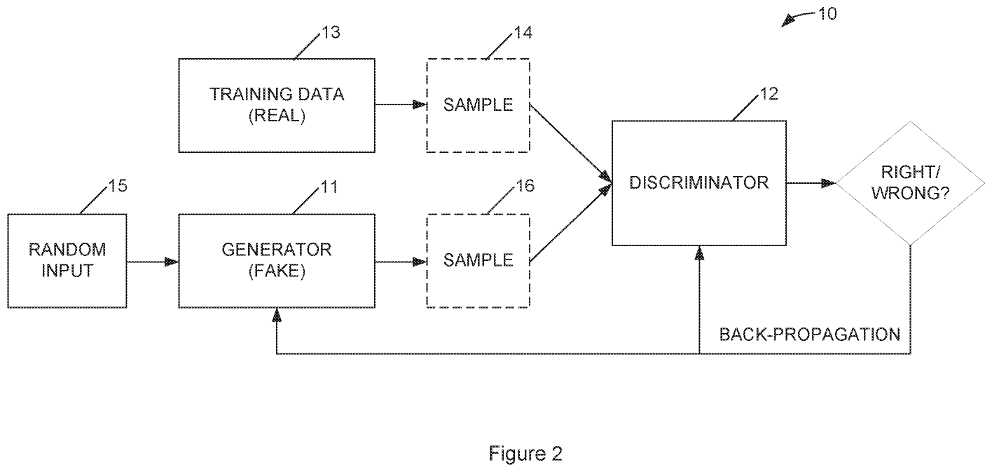

### DETAILED DESCRIPTION

For simplicity and illustrative purposes, the present invention is described by referring mainly to an exemplary embodiment thereof. In the following description, numerous specific details are set forth in order to provide a thorough understanding of the present invention. However, it will be readily apparent to one of ordinary skill in the art that the present invention may be practiced without limitation to these specific details. In this description, well known methods and structures have not been described in detail so as not to unnecessarily obscure the present invention.
A new Data Analytic Function (DAF), or analytic, is defined, as follows:
Analytic-ID=SyntheticData
Input: parameters=[A, B, C, . . . ], amount=n, . . . .
Output: {[A1, B1, C1, . . . ], . . . , [An, Bn, Cn, . . . ]

In greater detail, the SyntheticData analytic operates as follows. A consumer (e.g., a NF such as a central NWDAF, AF, or OAM) subscribes to NWDAF for the new SyntheticData analytic by triggering a Nnwdaf_AnalyticsSubscription_Subscribe request message, which includes the following parameters:

Analytic-ID set to “SyntheticData” (although those of skill in the art recognize that the new analytic is defined by its functionality, and not its label; accordingly, the specific label “SyntheticData” is not limiting).

Requested-Data-Parameters, which include, at a minimum:
Requested-Data-Type, set to, e.g., “IP data”
List of App-ID: this indicates the App-IDs which are the target for this analytic. When not present, any App-ID applies.
Requested-Data-Amount, set to, e.g., n.

As a representative but non-limiting example, the consumer might request NWDAF to generate a number “n” of IP packets for Netflix application.

Additional (optional) input parameters include:
UE-ID or list of UE-ID, UE-Group-ID or list of UE-Group-ID, AnyUE. This indicates the UEs which are the target for this analytic. When not present, AnyUE applies.
Other filter information, such as but not limited to: DNN, S-NSSAI, Area of Interest, RAT-Type.
Time-Period (e.g., one time, daily, weekly, monthly). This indicates the period for which the analytic applies.

Based on the analytic subscription, NWDAF triggers data collection from the UPF, in case the Requested-Data-Parameters refer to generation of user plane traffic data. Data collection from the UPF regarding user plane traffic for the requested application (App-ID), which may include, for example, raw IP packets, flow information including 5-tuples, URLs, or SNIs. Optionally, the NWDAF may trigger data collection from an AF (through NEF) or UE to instruct the endpoints (application client/server) to generate user plane traffic for the requested application. The NWDAF can request next the mapping of the flows generated by the endpoints with its correspondent label (e.g., flow-id 1: label App-ID1, flow 2: label App-ID 2)). This data collection refers to actual network traffic, which only used to train the GAN model (not to synthetic traffic). Once the GAN model is trained, no more network traffic data is collected.

Based on the data collected (e.g., from UPF), the NWDAF runs analytic processes using ML techniques, and using as input information the network traffic data collected, executes the analysis and learning processes to obtain the GAN model(s) to generate synthetic data for the Requested-Data-Parameters, and generates analytics output. The analytics output includes:
Analytic-ID, set to “SyntheticData” (a non-limiting name).
Analytic-Result, including the generated synthetic data, consisting of a number “n” of data units of the specified type (e.g., IP packets) for the target application (App-ID), as indicated in Requested-Data-Parameters.

The synthetic network traffic data generated and sent to the consumer may be used by the consumer for various actions, including training a ML model with the synthetic data. The synthetic data very closely mimics essential characteristics of actual network traffic. It is timely, and hence reflects the current (or very recent) configuration and operation of the network. The synthetic data does not include any information identifying any actual subscribers, and hence the consumer is not constrained, in use of the synthetic data, by privacy concerns. The data can be as voluminous as required for the ML training application, without overloading actual network nodes by duplicating and transporting copies of actual network traffic. Accordingly, the synthetic network traffic data is useful and hence valuable, and may represent a new source of revenue for MNOs.

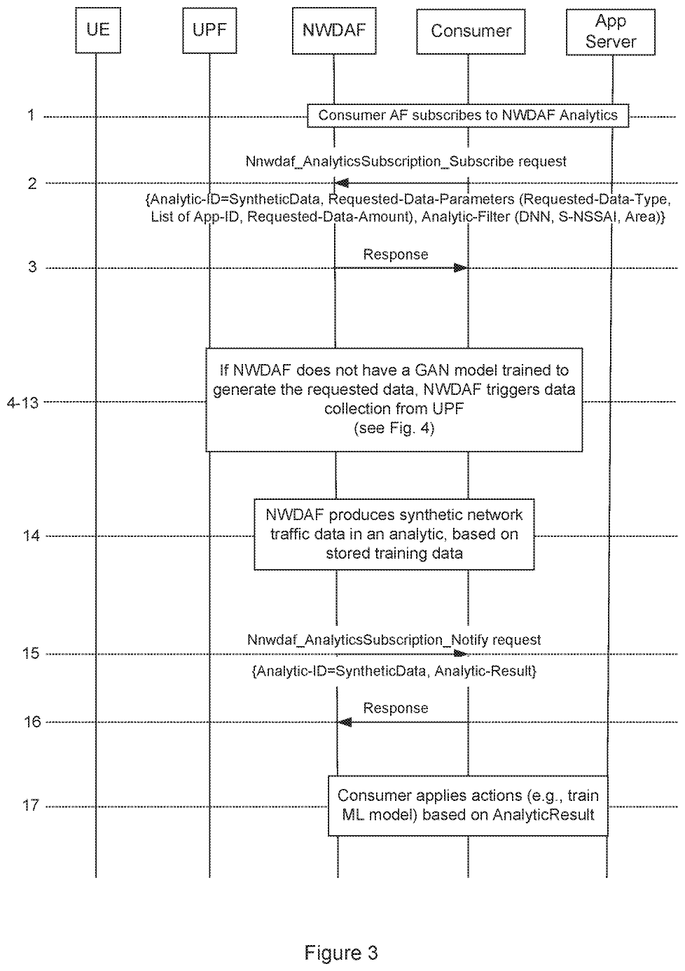

FIG. 3 depicts a network signaling diagram for the use case of a consumer requesting synthetic network traffic data, such as for example “n” IP packets for a Netflix application. The consumer may, for example, be a central NWDAF, OAM, AF, or the like.

At step 1, the consumer subscribes to the NWDAF analytics, the mechanics of which are well known by those of skill in the art. At step 2, the consumer requests a “SyntheticData” analytic by sending to the NWDAF a Nnwdaf_AnalyticsSubscription_Subscribe request message. The message includes the parameter Analytic-ID=SyntheticData, and a list of Requested-Data-Parameters. The parameters include Requested-Data-Type (e.g., IP packets); Requested-Data-Amount (e.g., “n” packets) and a List of App-ID (e.g., Netflix). The message may additionally include a list of Analytic-Filter parameters, such as a specific Domain Network Name (DNN), a particular network slice (identified by S-NSSAI), and a particular Area of the wireless communication network. As discussed above, other parameters and/or filter inputs may be included in the Nnwdaf_AnalyticsSubscription_Subscribe request message, depending on the data needs of the consumer. The NWDAF responds to the consumer at step 3, indicating successful receipt/subscription of its request.

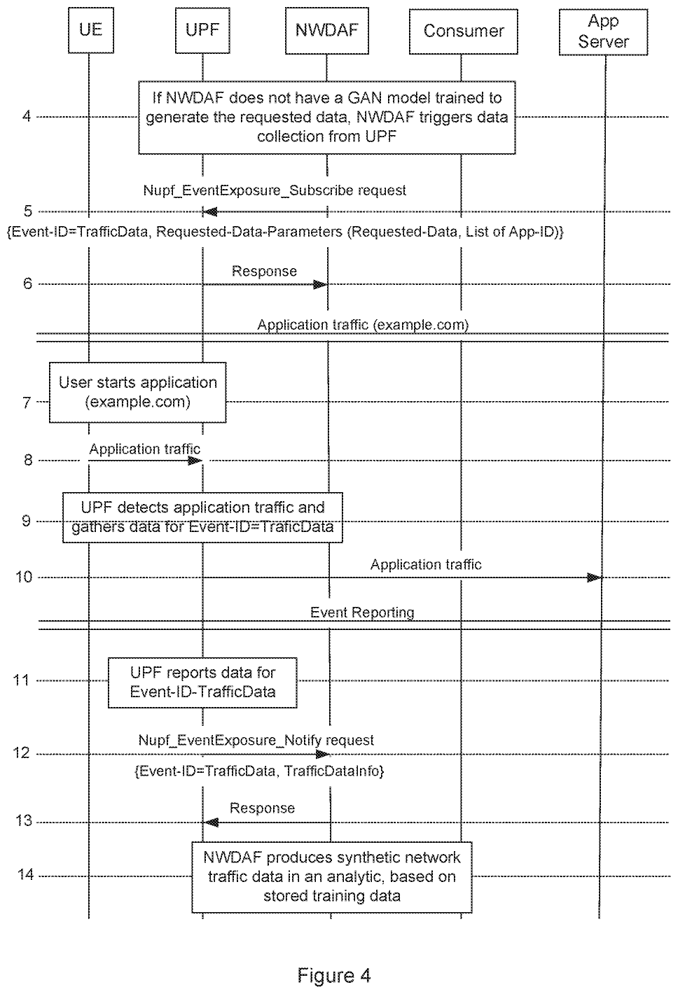

In this example, it is assumed the NWDAF has recently generated the same or substantially similar synthetic network traffic data, either for the same or a different consumer, and hence has a GAN model trained using actual network traffic. FIG. 4 depicts the case were the NWDAF does not have such a GAN model available, and must gather the actual network traffic data and construct one. As FIG. 4 depicts steps 4-13, FIG. 3 continues with step 14, in which the NWDAF produces synthetic network traffic data in an analytic, based on stored training data (e.g., in this case, stored actual network traffic data conforming to the requested parameters).

At step 15, the NWDAF sends a Nnwdaf_AnalyticsSubscription_Notify request message to the consumer. The message includes the parameter Analytic-ID=SyntheticData, and Analytic-Results. The Analytic-Results comprise, in this example, “n” IP packets of synthetic (i.e., generated by the NWDAF GAN model) network traffic data for the target App-ID (Netflix), in the specified DNN, network slice, and network area. The consumer acknowledges to the NWDAF successful receipt of the data at step 16.

At step 17, the consumer applies the synthetic network data to its actions, such as using the data to train one or more ML models.

Of course, the NWDAF will not always have a trained GAN model available, or stored training data (recent actual network traffic data) with which to generate every requested set of synthetic network traffic data. FIG. 4 depicts the signaling required for the NWDAF to generate such actual training data and train a GAN model. The numbering of steps in FIG. 4 is coordinated with those of FIG. 3.

At step 5, the NWDAF triggers data collection from the User Plane Function (UPF), e.g., by sending to the UPF a Nupf_EventExposure_Subscribe request message. This message includes the parameter Event-ID=TrafficData, and a list of Requested-Data-Parameters. The parameters generally match those requested by the consumer, such as the type of data requested, App-IDs, and the like. Those of skill in the art understand that mechanisms for the NWDAF to trigger data collection from the UPF are known (e.g., proposed in 3GPP TR 23.700-91, through SMF or directly, assuming a service based UPF). Accordingly, details of such data collection are not explicated herein. At step 6, the UPF answers the NWDAF, indicating successful receipt of the subscription request.

At steps 7 and 8, a user starts an application (e.g., example.com). At steps 9 and 10, the UPF detects the UE traffic, and gathers data for Event-ID=TrafficData. The UPF then forwards UE traffic to the Application Server. The UPF continues gathering actual network traffic data for Event-ID=TrafficData.

At some point, such as a periodic reporting trigger, the UPF reports its collected data to the NWDAF by triggering a Nupf_EventExposure_Notify request message including the parameter Event-ID=TrafficData, and TrafficDataInfo. The TrafficDataInfo includes information relative to user plane traffic (e.g., flow information, URLs, SNIs) for the target App-ID. Alternatively, instead of reporting the above metadata, UPF might report mirrored data (i.e., raw IP packets). At step 13, the NWDAF answers UPF indicating successful operation. Note that steps 11-13 may repeat numerous times, depending on the quantity of actual network traffic data the NWDAF requires for training a GAN.

At step 14 the NWDAF produces analytics based on the collected actual network traffic data. For example, the NWDAF uses the collected actual network traffic as training data in a GAN model, and trains the model until it generates synthetic network traffic that rivals the actual network traffic data, as determined by the GAN model's discriminator. Note that step 14 is the same as step 14 in FIG. 3, and the process continues at step 15 in FIG. 3.

The term NetWork Data Analytics Function (NWDAF) indicates a NF comprising one or more discrete logical functions. One such discrete logical function is the Analytics logical function (AnLF). An NWDAF containing AnLF can perform inference, derive analytics information (i.e., derives statistics and/or predictions based on Analytics Consumer request) and expose analytics service, i.e., Nnwdaf_AnalyticsSubscription or Nnwdaf_AnalyticsInfo.

Another known discrete logical function is the Model Training logical function (MTLF). An NWDAF containing MTLF trains Machine Learning (ML) models and exposes new training services (e.g., providing trained ML model).

According to embodiments of the present invention, a new NWDAF logical function, the Data Generator logical function (DGLF) is defined. An NWDAF containing DGLF stores trained GAN models with their parameters and exposes the generation data service (e.g., providing synthetic and anonymized data).

In some embodiments, the new NWDAF containing DGLF acts as a Consumer of NWDAF containing MTLF, in that the MTLF provides a trained GAN model.

In some embodiments, the new NWDAF containing DGLF acts as a Producer. It generates synthetic data to be consumed by other NWDAF logical functions (e.g., MTLF, for training or validation; or AnLF), and/or other NFs (e.g., for testing or training ML models).

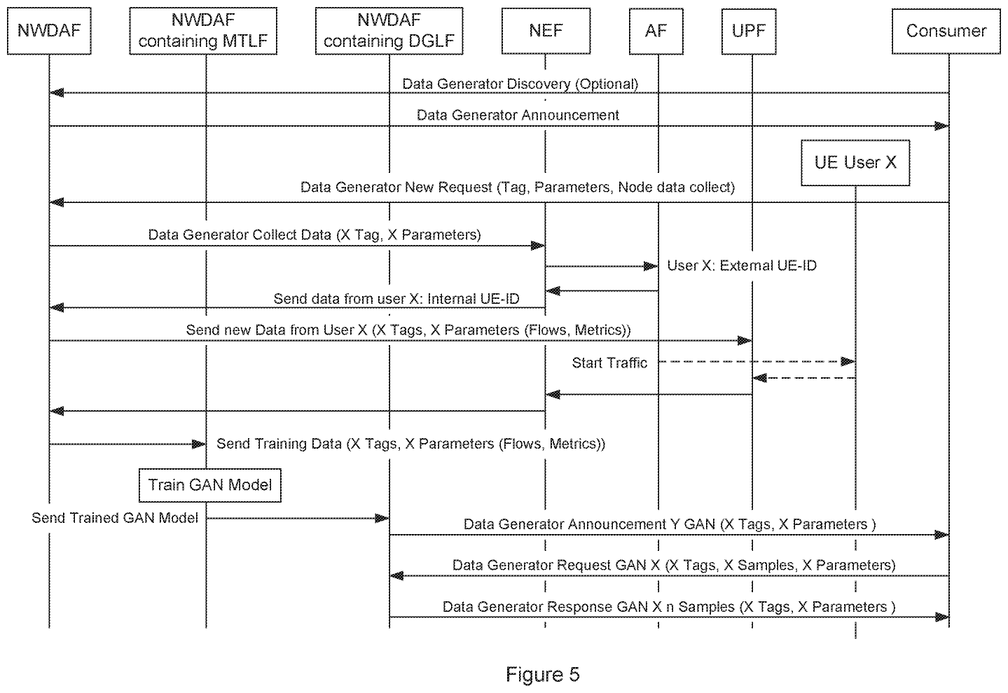

One example of interaction between a NWDAF containing MTLF and NWDAF containing DGLF logical functions is a use case of training ML models for traffic classification, using a plurality of controlled UEs. FIG. 5 depicts this process. The NWDAF triggers data collection from AF (through NEF) to instruct the application client/server to generate traffic of a certain application for the controlled devices (e.g., a plurality of UEs). The NWDAF triggers data collection from the UPF, which detects traffic generated by the controlled UEs. The NWDAF correlates collected data based on a mapping of flows to services (e.g., flow id 1—netflix with video; flow id2—netflix no video), and a tag which could be the service, the operating system, use case (video, audio) or a combination.

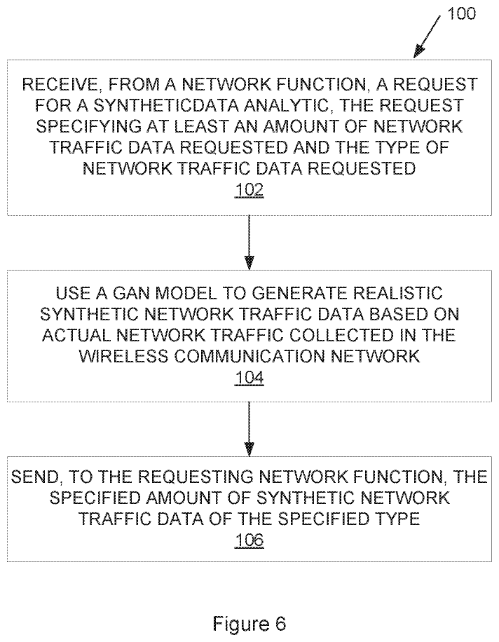

FIG. 6 depicts a method 200 of generating realistic synthetic network traffic data, performed by a data analytics function of a wireless communication network, in accordance with particular embodiments. A request for a SyntheticData analytic is received from a network function (block 102). The request specifies at least an amount of data requested and the type of data requested. A Generative Adversarial Network (GAN) model is used to generate realistic synthetic network traffic data based on actual network traffic collected in the wireless communication network (block 104). The specified amount of synthetic network traffic data, of the specified type, is sent to the requesting network function.

The apparatus described herein may perform the method 100 herein and any other processing by implementing any functional means, modules, units, or circuitry. In one embodiment, for example, the apparatuses comprise respective circuits or circuitry configured to perform the steps shown in the method figures. The circuits or circuitry in this regard may comprise circuits dedicated to performing certain functional processing and/or one or more microprocessors in conjunction with memory. For instance, the circuitry may include one or more microprocessor or microcontrollers, as well as other digital hardware, which may include digital signal processors (DSPs), special-purpose digital logic, and the like. The processing circuitry may be configured to execute program code stored in memory, which may include one or several types of memory such as read-only memory (ROM), random-access memory, cache memory, flash memory devices, optical storage devices, etc. Program code stored in memory may include program instructions for executing one or more telecommunications and/or data communications protocols as well as instructions for carrying out one or more of the techniques described herein, in several embodiments. In embodiments that employ memory, the memory stores program code that, when executed by the one or more processors, carries out the techniques described herein.

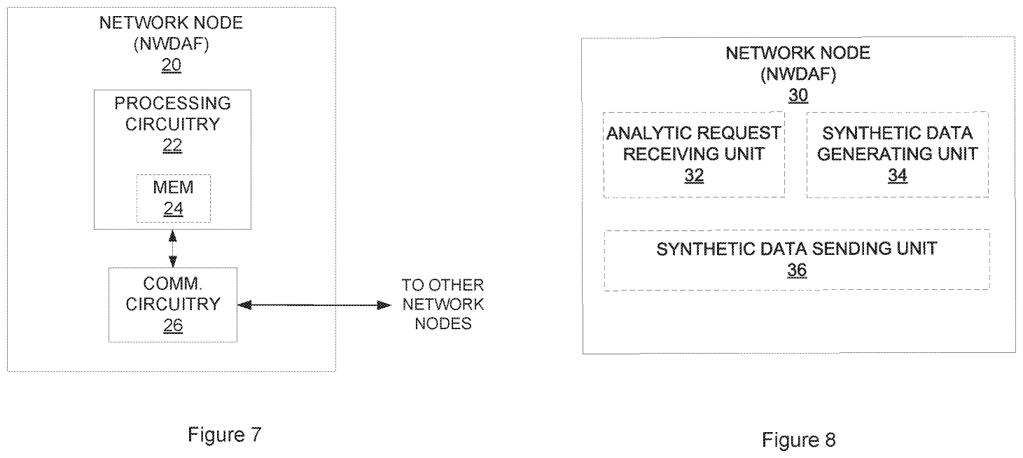

FIG. 7 for example illustrates a hardware block diagram of a network node 20 operative in a wireless communication network. The network node 20 may implement a NetWork Data Analytics Function (NWDAF). The network node 20 includes processing circuitry 22; memory 24; and communication circuitry 26. Although the memory 24 is depicted as being internal to the processing circuitry 22, those of skill in the art understand that the memory 24 may also be external. Those of skill in the art additionally understand that virtualization techniques allow some functions nominally executed by the processing circuitry 22 to actually be executed by other hardware, perhaps remotely located (e.g., in the so-called “cloud”).

According to one embodiment of the present invention, the processing circuitry 22 is operative to cause the network node 20 to generate realistic synthetic network traffic data. In particular, the processing circuitry 22 is operative to perform the method 100 described and claimed herein. The processing circuitry 22 in this regard may implement certain functional means, units, or modules.

FIG. 8 illustrates a functional block diagram of a network node 30 in a wireless communication network according to still other embodiments. As shown, the network node 30 implements various functional means, units, or modules, e.g., via the processing circuitry 22 in FIG. 7 and/or via software code. These functional means, units, or modules, e.g., for implementing the method 100 herein, include for instance: an analytic request receiving unit 32, a synthetic data generating unit 34, and a synthetic data sending unit 36.

The analytic request receiving unit 32 is configured to receive, from a network function, a request for a SyntheticData analytic, the request specifying at least an amount of data requested and the type of data requested. The synthetic data generating unit 34 is configured to use a Generative Adversarial Network (GAN) model to generate realistic synthetic network traffic data based on actual network traffic collected in the wireless communication network. The synthetic data sending unit 36 is configured to send, to the requesting network function, the specified amount of synthetic network traffic data of the specified type.

Those skilled in the art will also appreciate that embodiments herein further include corresponding computer programs.

A computer program comprises instructions which, when executed on at least one processor of an apparatus, cause the apparatus to carry out any of the respective processing described above. A computer program in this regard may comprise one or more code modules corresponding to the means or units described above.

Embodiments further include a carrier containing such a computer program. This carrier may comprise one of an electronic signal, optical signal, radio signal, or computer readable storage medium.

In this regard, embodiments herein also include a computer program product stored on a non-transitory computer readable (storage or recording) medium and comprising instructions that, when executed by a processor of an apparatus, cause the apparatus to perform as described above.

Embodiments further include a computer program product comprising program code portions for performing the steps of any of the embodiments herein when the computer program product is executed by a computing device. This computer program product may be stored on a computer readable recording medium.

Embodiments of the present invention present numerous advantages over the prior art. For example, they allow a network operator to generate synthetic data that can be used as training set for new ML models; to validate and retrain existing ML models; to discriminate between fraud vs real traffic; for offline training; and to send synthetic data from local NWDAF to central NWDAF. Embodiments of the present invention allow network operator to avoid the collapse of network interfaces to due to high volume traffic transmissions that may occur if actual network traffic data were collected, stored, and transported for these uses. This is due to the fact that only a much smaller amount, or percentage, or the needed network traffic data is sent from the UPF to the NWDAF-the data used to train the GAN. Afterwards, no actual network traffic needs to be sent from the UPF to the NWDAF, but instead virtually unlimited amounts of synthetic network traffic data is sent from the NWDAF DGLF (GAN) to the consumer NF. These data are anonymous and raise no privacy concerns. The GAN can be retrained relatively frequently, so the synthetic network traffic data always reflects the most current state of the network.

The term “unit” may have conventional meaning in the field of electronics, electrical devices and/or electronic devices and may include, for example, electrical and/or electronic circuitry, devices, modules, processors, memories, logic solid state and/or discrete devices, computer programs or instructions for carrying out respective tasks, procedures, computations, outputs, and/or displaying functions, and so on, as such as those that are described herein. As used herein, the term “configured to” means set up, organized, adapted, or arranged to operate in a particular way; the term is synonymous with “designed to.”

The present invention may, of course, be carried out in other ways than those specifically set forth herein without departing from essential characteristics of the invention. The present embodiments are to be considered in all respects as illustrative and not restrictive, and all changes coming within the meaning and equivalency range of the appended claims are intended to be embraced therein.

1. A method, performed by a network data analytics function of a wireless communication network, of generating realistic synthetic network traffic data, the method comprising:
receiving, from a network function, a request for a SyntheticData analytic, the request specifying at least an amount of network traffic data requested and the type of network traffic data requested;
using a Generative Adversarial Network, GAN, model to generate realistic synthetic network traffic data based on actual network traffic collected in the wireless communication network; and
sending, to the requesting network function, the specified amount of synthetic network traffic data of the specified type.

2. The method of claim 1, wherein the SyntheticData analytic request further specifies one or more of:
an App-ID identifying an application which is a target of the analytic;
one or more UE-IDs or UE-Group-IDs identifying one or more User Equipment, UE, or defined groups of UEs, respectively, which are targets of the analytic; and
a time period for which the analytic applies.

3. The method of claim 1, wherein the SyntheticData analytic request further specifies one or more filter parameters, including:
Data Network Name, DNN;
Single-Network Slice Selection Assistance Information, S-NSSAI;
Area of Interest; and
Radio Access Technology, RAT, type.

4. The method of claim 1, further comprising, if a GAN model for the requested parameters does not exist:
collecting actual network traffic data from a User Plane Function, UPF, in the wireless communication network; and
using the collected actual network traffic data to execute analysis and learning processes to obtain a GAN model configured to generate synthetic data according to parameters specified in the SyntheticData analytic request.

5. The method of claim 4, wherein using the collected actual network traffic data to execute analysis and learning processes to obtain a GAN model comprises:
sending the collected actual network traffic data to a model training logical function of a network data analytics function; and
receiving a trained GAN model from the model training logical function.

6. The method of claim 4, wherein the actual network traffic data collected from the UPF includes one or more of:
raw Internet Protocol, IP, packets;
flow information including 5-tuples;
Uniform Resource Locators, URLs; and
Server Name Indication (SNI).

7. The method of claim 4, further comprising, prior to collecting actual network traffic data from the UPF:
instructing one or both of an Application Function, AF, and User Equipment, UE, as the endpoints of communication through the wireless communication network, to generate user plane traffic for the requested application.

8. The method of claim 7, further comprising mapping the generated data flow between the endpoints with a correspondent label.

9. The method of claim 1, wherein sending the synthetic network traffic data to the requesting network function comprises generating a SyntheticData analytic output including:
Analytic-Id set to “SyntheticData”; and
Analytic-Result including the amount of synthetic network traffic data, of the type, specified in the request for the SyntheticData analytic.

10. A network node, operative in a wireless communication network and implementing a network data analytics function, the network node comprising:
communication circuitry configured to communicate with other nodes of the wireless communication network; and
processing circuitry, operatively connected to the communication circuitry and configured to:
receive, from a network function, a request for a SyntheticData analytic, the request specifying at least an amount of network traffic data requested and the type of network traffic data requested;
use a Generative Adversarial Network, GAN, model to generate realistic synthetic network traffic data based on actual network traffic collected in the wireless communication network; and
send, to the requesting network function, the specified amount of synthetic network traffic data of the specified type.

11. The network node of claim 10, wherein the SyntheticData analytic request further specifies one or more of:
an App-ID identifying an application which is a target of the analytic;
one or more UE-IDs or UE-Group-IDs identifying one or more User Equipment, UE, or defined groups of UEs, respectively, which are targets of the analytic; and
a time period for which the analytic applies.

12. The network node of claim 10, wherein the SyntheticData analytic request further specifies one or more filter parameters, including:
Data Network Name, DNN;
Single-Network Slice Selection Assistance Information, S-NSSAI;
Area of Interest; and
Radio Access Technology, RAT, type.

13. The network node of claim 10, wherein the processing circuitry is further configured to, if a GAN model for the requested parameters does not exist:
collect actual network traffic data from a User Plane Function, UPF, in the wireless communication network; and
use the collected actual network traffic data to execute analysis and learning processes to obtain a GAN model configured to generate synthetic data according to parameters specified in the SyntheticData analytic request.

14. The network node of claim 13, wherein using the collected actual network traffic data to execute analysis and learning processes to obtain a GAN model comprises:
sending the collected actual network traffic data to a model training logical function of a network data analytics function; and
receiving a trained GAN model from the model training logical function.

15. The network node of claim 13, wherein the actual network traffic data collected from the UPF includes one or more of:
raw Internet Protocol, IP, packets;
flow information including 5-tuples;
Uniform Resource Locators, URLs; and
Server Name Indication (SNI).

16. The network node of claim 13, wherein the processing circuitry is further configured to, prior to collecting actual network traffic data from the UPF:
instruct one or both of an Application Function, AF, and User Equipment, UE, as the endpoints of communication through the wireless communication network, to generate user plane traffic for the requested application.

17. The network node of claim 16, wherein the processing circuitry is further configured to map the generated data flow between the endpoints with a correspondent label.

18. The network node of claim 10, wherein sending the synthetic network traffic data to the requesting network function is characterized by generating a SyntheticData analytic output including:
Analytic-Id set to “SyntheticData”; and
Analytic-Result including the amount of synthetic network traffic data, of the type, specified in the request for the SyntheticData analytic.

19. The network node of claim 10, wherein the processing circuitry is further configured to implement a Data Generator Logical Function, DGLF.

20. A computer-readable storage medium containing instructions which, when executed by processing circuitry of a network node, are configured to cause the processing circuitry to perform a method, the method comprising:
receiving, from a network function, a request for a SyntheticData analytic, the request specifying at least an amount of network traffic data requested and the type of network traffic data requested;
using a Generative Adversarial Network, GAN, model to generate realistic synthetic network traffic data based on actual network traffic collected in the wireless communication network; and
sending, to the requesting network function, the specified amount of synthetic network traffic data of the specified type.

21.-28. (canceled).
